(19) United States
(12) Patent Application Publication
(10) Pub. No.: US 2026/0038978 A1
(43) Pub. Date: Feb. 5, 2026

(54) Battery Module and Manufacturing Method of the Same

(71) Applicant: SK On Co., Ltd., Seoul (KR)

(72) Inventors: Jae Hun KIM, Daejeon (KR); Tae Wan KIM, Daejeon (KR); Yoon Sung OH, Daejeon (KR); Ki Dong LEE, Daejeon (KR)

(21) Appl. No.: 19/246,956

(22) Filed: Jun. 24, 2025

(30) Foreign Application Priority Data
Jul. 31, 2024 (KR) 10-2024-0101798

(51) Int. Cl. H01M 50/516; H01M 50/211; H01M 50/503; H01M 50/505

(52) U.S. Cl. CPC H01M 50/516; H01M 50/211; H01M 50/503; H01M 50/505

(57) ABSTRACT

A battery module according to the present disclosure includes a plurality of battery cells each including an exterior material and an electrode lead protruding to one side, and stacked in a predetermined stacking direction, and a busbar assembly facing the plurality of battery cells and electrically connected to the electrode lead, wherein the electrode lead includes a first region located at a free end and a second region connected to the exterior material, and wherein the first region is located inward relative to one surface of the busbar assembly.

### CROSS-REFERENCE TO RELATED PATENT APPLICATION

The present application claims priority under 35 U.S.C. § 119(a) to Korean patent application number 10-2024-0101798 filed on Jul. 31, 2024 in the Korean Intellectual Property Office, the entire disclosure of which is incorporated by reference herein.

### BACKGROUND OF THE INVENTION

### 1. Field

The present disclosure relates to a battery module and a manufacturing method thereof.

### 2. Description of the Related Art

Secondary batteries convert electrical energy into chemical energy and store the chemical energy so that the secondary batteries may be reused multiple times through charging and discharging. Secondary batteries are widely used throughout the industry due to their economical and eco-friendly characteristics. In particular, lithium secondary batteries are widely used in the entire industry, including portable devices which require high-density energy.

The operating principle of lithium secondary batteries is the electrochemical oxidation-reduction reaction. In other words, electricity is generated by the movement of lithium ions and is charged in the opposite process. In the case of a lithium secondary battery, a phenomenon in which lithium ions from an anode escape and move to a cathode through an electrolyte and a separator is called discharge. In addition, the opposite process of the phenomenon is called charge.

### SUMMARY OF THE INVENTION

An aspect of the present disclosure is to provide a battery module with improved stability.

Another aspect of the present disclosure is to provide a method of manufacturing a battery module with improved production efficiency.

The present disclosure may be widely applied in the fields of electric vehicles, battery charging stations, and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

A battery module according to embodiments of the present disclosure may include a plurality of battery cells each including an exterior material and an electrode lead protruding to one side, and stacked in a predetermined stacking direction, and a busbar assembly facing the plurality of battery cells and electrically connected to the electrode lead, wherein the electrode lead includes a first region located at a free end and a second region connected to the exterior material, and wherein the first region is located inward relative to one surface of the busbar assembly.

The busbar assembly may include a plurality of slits, and the electrode lead may be inserted into each of the plurality of slits.

The plurality of slits may be spaced apart from each other in the predetermined stacking direction.

The battery module may include a weld bead formed by melting at least a part of the first region and a part of the busbar assembly.

The weld bead may be located inward relative to the one surface of the busbar assembly.

The busbar assembly may include a body portion extending in the predetermined stacking direction and a plurality of leg portions extending from the body portion in a height direction perpendicular to the predetermined stacking direction and a protruding direction of the electrode lead to form the plurality of slits.

The weld bead may be located inward relative to the one surface of the plurality of leg portions.

The busbar assembly further may include a plurality of support portions extending from one side of the plurality of leg portions toward the plurality of slits and arranged to face each other.

A width between the plurality of leg portions in the predetermined stacking direction may be greater than a width of the first region, and the width of the first region may be greater than a width between the plurality of support portions.

The weld bead may be located on the plurality of support portions.

The weld bead may extend in a height direction perpendicular to the predetermined stacking direction and a protruding direction of the electrode lead.

The battery module may include a busbar cover covering the busbar assembly, wherein the busbar cover is in contact with the first region.

The busbar cover may include protrusions in which portions of the busbar cover at positions corresponding to the plurality of slits protrude toward the electrode lead.

A method of manufacturing a battery module including a plurality of battery cells each including an electrode lead protruding to one side and stacked in a predetermined stacking direction, and a busbar assembly facing the plurality of battery cells and electrically connected to the electrode lead according to embodiments of the present disclosure may include inserting the electrode lead into each of a plurality of slits penetrating one surface of the busbar assembly, and pressing the busbar assembly such that a free end of the electrode lead is located inward relative to the one surface of the busbar assembly.

The inserting the electrode lead may include moving the busbar assembly in a height direction perpendicular to the predetermined stacking direction and a protruding direction of the electrode lead.

The method may further include pressing the electrode lead in a protruding direction of the electrode lead by a guide block.

The method may further include forming a weld bead by melting a part of the electrode lead and a part of the busbar assembly.

The forming the weld bead may include irradiating the electrode lead with a laser in a direction perpendicular to the one surface of the busbar assembly.

In the forming of the weld bead, the weld bead may be formed inward in a protruding direction of the electrode lead relative to the one surface of the busbar assembly.

The method may further include covering the busbar assembly and contacting the electrode lead by a busbar cover.

### BRIEF DESCRIPTION OF THE DRAWINGS

FIG. 1 is an exploded view of a battery module according to an embodiment of the present disclosure.

FIG. 2 is a view of a battery cell according to an embodiment of the present disclosure.

FIG. 3 is a view showing a state in which a first region is manufactured according to an embodiment of the present disclosure.

FIGS. 4 to 6 are views of electrode leads and a busbar assembly according to an embodiment of the present disclosure.

FIG. 7 is an enlarged view of a cross-section of a region S in FIG. 6.

FIG. 8 is a view showing a state in which an electrode lead is pressed according to an embodiment of the present disclosure.

FIG. 9 is a view showing a state in which electrode leads and a busbar assembly are welded according to the embodiment of the present disclosure.

FIGS. 10 to 13 are views showing a state in which electrode leads and a busbar assembly are welded according to the embodiment of the present disclosure.

FIG. 14 is a view of an electrode lead according to another embodiment of the present disclosure.

FIGS. 15 and 16 are views of a busbar cover according to an embodiment of the present disclosure.

FIGS. 17 and 18 are views of an order of a method of manufacturing a battery module according to the embodiment of the present disclosure.

### DETAILED DESCRIPTION

Hereinafter, the present disclosure will be described in detail with reference to the accompanying drawings. This is, however, illustrative only and not intended to limit the disclosure to the specific embodiments illustratively described.

The specific terms used herein are for convenience of description only and are not intended to be limiting exemplary embodiments.

For example, expressions such as “same” and “being same” indicate not only a state in which they are strictly the same, but also a state in which there is a tolerance or a difference in the degree to which the same function is obtained.

For example, expressions indicating relative or absolute arrangement such as “in a direction,” “along a direction,” “in parallel,” “vertically,” “centrally,” “concentrically,” or “coaxially” not only strictly indicate such arrangements, but also indicate a state of relative displacement with tolerances or an angle or distance to the extent that the same function is obtained.

To explain the present disclosure, descriptions below may be based on a spatial orthogonal coordinate system with X, Y, and Z axes orthogonal to each other. Each axis direction (X-axis direction, Y-axis direction, Z-axis direction) refers to both directions in which each axis extends.

The X-direction, Y-direction, and Z-direction mentioned below are for the purpose of explanation, so that the present disclosure may be clearly understood. The directions may be defined differently depending on where the reference is placed.

The use of terms such as ‘first, second, and third’ in front of the components mentioned below is only to avoid confusion about the components to which they are referred and is irrelevant to the order, importance, or master-slave relationship between the components, etc. For example, an embodiment that includes only a second component without a first component may also be implemented.

It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise.

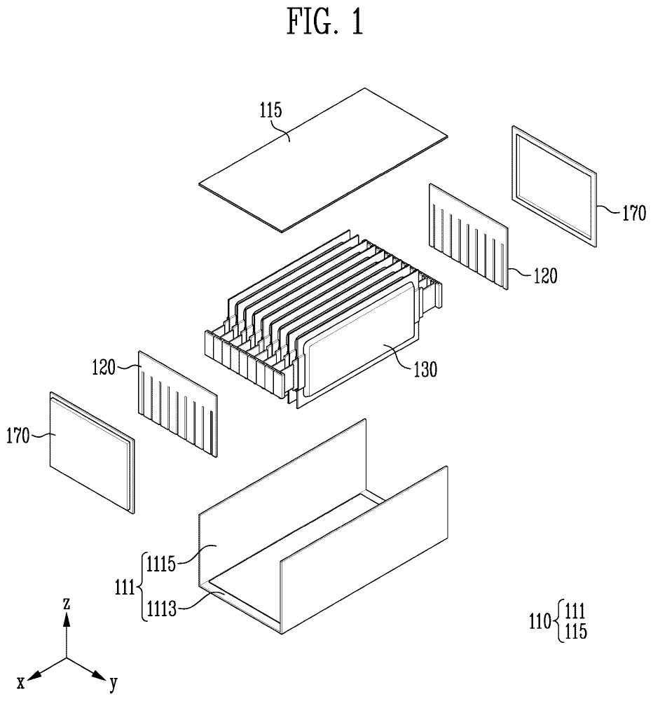

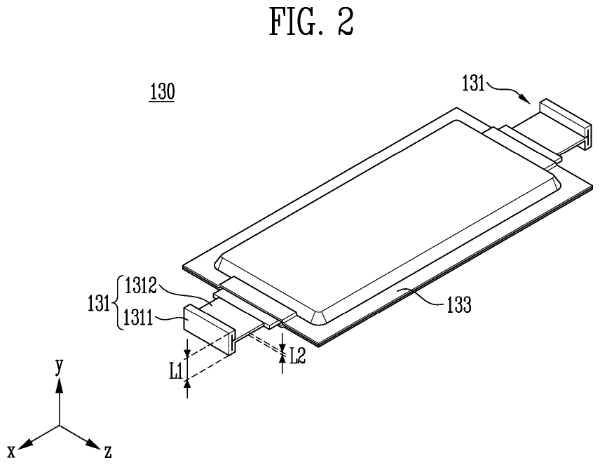

FIG. 1 is an exploded view of a battery module 100 according to an embodiment of the present disclosure, and FIG. 2 illustrates a battery cell 130 according to an embodiment.

The battery module 100 of the present disclosure includes: the plurality of battery cells 130 each including an exterior material 133 and an electrode lead 131 protruding to one side and stacked in a predetermined stacking direction; and a busbar assembly 120 facing the plurality of battery cells 130 and electrically connected to the electrode leads 131. The electrode lead 131 includes a first region 1311 located at a free end and a second region 1312 connected to the exterior material 133, and the first region 1311 may be located inward relative to one surface of the busbar assembly 120.

The battery cell 130 of the present disclosure refers to a secondary battery which may be repeatedly used by charging and discharging electric energy. For example, the secondary battery may refer to a lithium secondary battery or a lithium ion battery, but the present disclosure is not limited thereto. As another example, the secondary battery may refer to a solid-state battery.

The battery cell 130 may be classified into a pouch-type secondary battery, a prismatic secondary battery, or a cylindrical secondary battery depending on the shape thereof. Referring to FIG. 1, for convenience of description, a pouch-type secondary battery is shown as an example in the present specification, but the present disclosure is not limited thereto.

The battery module 100 herein refers to a battery assembly in which one or more of the battery cells 130 are grouped and put in a case to protect the battery cells 130 from external shocks, heat, and vibrations and to achieve high output and high capacity characteristics.

The battery cell 130 may include a cathode and an anode. The cathode may include a cathode active material into and from which lithium ions may be inserted and extracted. The anode may include an anode active material into and from which lithium ions may be inserted and extracted. The battery cell 130 may further include a separator for preventing an electrical short circuit due to contact between the cathode and the anode.

In an embodiment, an anode, a cathode, and a separator may be stacked to form an electrode assembly. The electrode assembly may be classified into a stacking, winding, stack-folding, or z-stacking type electrode assembly, depending on the manner in which the cathode, the anode, and the separator are stacked. The battery cell 130 of the present disclosure is not limited to any one stacking method, and may include an electrode assembly stacked in various ways. As a result, the battery cell 130 of the present disclosure including an electrode assembly stacked in various ways may store and supply electrical energy.

The battery cell 130 may further include the exterior material 133. An electrode assembly and an electrolyte may be accommodated in the exterior material 133. In an embodiment, the exterior material 133 may include an outer insulating layer and an inner adhesive layer made of a polymer, and a metal layer interposed between the outer insulating layer and the inner adhesive layer. The exterior material 133 may include a material having high mechanical rigidity to protect the battery cell 130 from external impact. For example, the exterior material 133 may include an aluminum layer.

The battery cell 130 may further include the electrode lead 131 protruding to the outside of the exterior material 133 for electrical connection with the outside. The electrode lead 131 may be connected to the anode and the cathode of the battery cell 130, respectively.

The electrode lead 131 may include a plurality of electrode leads. In an embodiment, there may be two electrode leads 131. One electrode lead 131 may protrude to one side of the exterior material 133. The other electrode lead 131 may protrude to the other side opposite to the one side of the exterior material 133.

Referring to FIG. 1, the electrode leads 131 may protrude to one side and the other side of the exterior material 133 in an X-axis direction. In this specification, the protruding direction of the electrode lead 131 may mean a direction parallel to the X-axis direction.

The electrode lead 131 may include the first region 1311 and the second region 1312. The first region 1311 may be located at the free end of the electrode lead 131. The first region 1311 may mean an end portion of one side of the electrode lead 131 which faces the outside. The second region 1312 may be a region where the electrode lead 131 is connected to the exterior material 133.

The second region 1312 and the first region 1311 may be sequentially positioned in a direction in which the electrode lead 131 moves away from the exterior material 133. In an embodiment, the first region 1311 and the second region 1312 may be integrally formed. The first region 1311 and the second region 1312 may include the same material.

The shape of the first region 1311 may be different from that of the second region 1312. In an embodiment, the width of the first region 1311 in the stacking direction may be greater than the width of the second region 1312. Referring to FIG. 2, a width L1 of the first region 1311 may be greater than a width L2 of the second region 1312.

In an embodiment, the width L1 of the first region 1311 may be less than or equal to the thickness of the battery cell 130. The thickness of the battery cell 130 may mean the length of the battery cell 13 in the stacking direction. In this manner, the efficiency of stacking the battery cells 130 may be improved. More specifically, when the width of the first region 1311 is greater than the width of the battery cell 130, it may not be possible to stack a large number of battery cells 130 due to the first region 1311.

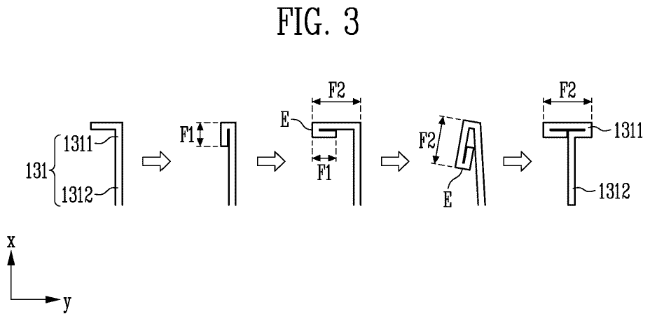

FIG. 3 illustrates a state in which the first region 1321 is manufactured according to an embodiment of the present disclosure. More specifically, FIG. 3 shows only a part of the first region 1311 and the second region 1312 of the electrode lead 131.

The first region 1311 may be folded a plurality times. The first region 1311 may be folded in different directions. For example, the first region 1311 may be folded in a direction toward one surface of the battery cell 130. In addition, the first region 1311 may be folded in a direction toward the other surface of the battery cell 130 opposite to the one surface of the battery cells 130.

In an embodiment, the first region 1311 may first be folded such that a part of the first region 1311 overlaps by a predetermined first length F1. Thereafter, the first region 1311 may be folded at a position spaced apart from one end E of the folded first region 1311 by a predetermined second length F2. Thereafter, the first region 1311 may be folded in an opposite direction to the preceding folding direction.

By folding the first region 1311 a plurality of times, a part of the first region 1311 may overlap by the predetermined second length F2. The predetermined second length F2 may be changed in consideration of the manufacturing process and performance.

In an embodiment, the predetermined second length F2 may be the width L1 of the first region to be described below.

Each of the plurality of battery cells 130 may include the exterior material 133 and the electrode lead 131. The plurality of battery cells 130 may be stacked in the predetermined stacking direction. Referring to FIG. 1, the plurality of battery cells 130 may be stacked in a Y-axis direction. In this specification, the predetermined stacking direction may mean a direction parallel to the Y-axis direction.

The battery module 100 may further include a housing 110. The housing 110 may accommodate the plurality of battery cells 130 therein. The housing 110 may include an accommodating cover 115 and an accommodating body 111.

The accommodating body 111 may support the plurality of battery cells 130. The accommodating body 111 may include a lower body 1113 and a side body 1115. The lower body 1113 may support a lower portion of the battery cell 130. The side body 1115 may be connected to the lower body 1113 to cover side surfaces of the plurality of battery cells 130.

In an embodiment, the side body 1115 may extend upward from both opposing corners of the lower body 1113. In an embodiment, the lower body 1113 may be integrally formed with the side body 1115. In an embodiment, the accommodating body 111 may have a channel structure in which front and rear sides are open and a top side is open.

The accommodating cover 115 may be connected to the accommodating body 111 to cover an internal accommodation space of the accommodating body 111. The accommodating cover 115 may be connected to the side body 1115. Referring to FIG. 1, the accommodating cover 115 may be connected to the accommodating body 111 to form one surface of the accommodation space.

The battery module 100 may further include an end cover 170. The end cover 170 may be connected to the accommodating body 111. The end cover 170 may form a side surface of an internal accommodation space of the accommodating body 111. In an embodiment, the housing 110 may be connected to the end cover 170 to form an accommodation space therein and protect the plurality of battery cells 130.

The busbar assembly 120 may face the plurality of battery cells 130. In an embodiment, the busbar assembly 120 may face at least some of the plurality of battery cells 130.

The busbar assembly 120 may include plurality of busbar assemblies. The busbar assemblies 120 may be located on one side and the other side of the plurality of battery cells 130, respectively. In an embodiment, the plurality of busbar assemblies 120 may also be located on one side of the plurality of battery cells 130.

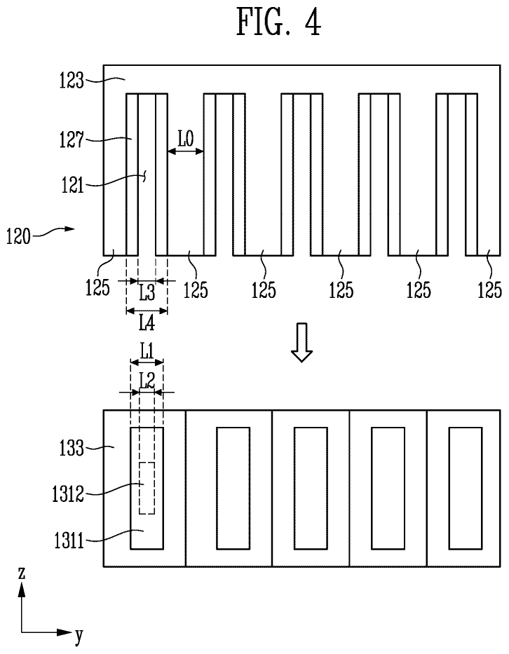

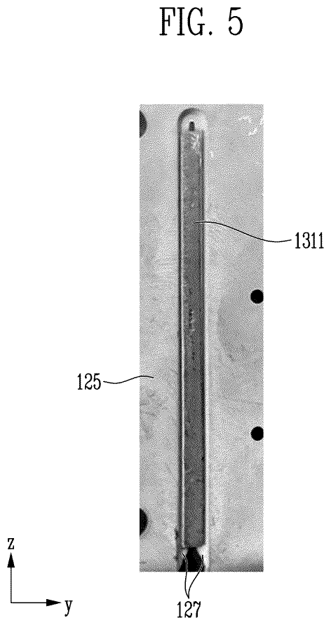

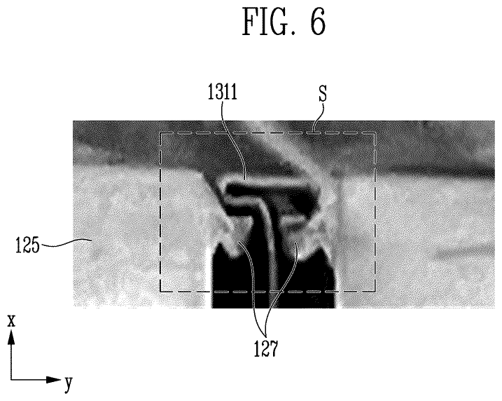

The busbar assembly 120 may extend in the stacking direction. The busbar assembly 120 extends in a direction in which the plurality of battery cells 130 are stacked, so that the busbar assembly 120 may face the plurality of battery cells 130. Referring to FIG. 1, the busbar assembly 120 may extend in the Y-axis direction. FIGS. 4 to 6 illustrate the electrode lead 131 and the busbar assembly 120 according to an embodiment of the present disclosure. More specifically, FIG. 4 shows a state before the electrode leads 131 are inserted into the busbar assembly 120. FIG. 5 is a photograph of the electrode lead 131 inserted into the busbar assembly 120. FIG. 6 illustrates a view from below of the electrode lead 131 inserted into the busbar assembly 120.

The busbar assembly 120 may include a plurality of slits 121, and the electrode leads 131 may be inserted into the plurality of slits 121, respectively. The plurality of slits 121 may be formed through the busbar assembly 120. In an embodiment, each of the plurality of slits 121 may be formed through the busbar assembly 120 in the protruding direction of the electrode leads 131.

The plurality of slits 121 may be spaced apart from each other in the stacking direction. Thus, the electrode leads 131 may be inserted into the plurality of slits 121, respectively.

The structure of the busbar assembly 120 will be described in detail with reference to FIGS. 4 and 6. The busbar assembly 120 may include a body portion 123 extending in the stacking direction, and a plurality of leg portions 125 extending from the body portion 123 in a height direction perpendicular to the stacking direction and the protruding direction of the electrode lead 131 to form the plurality of slits 121.

Each of the plurality of leg portions 125 may extend in one area of the body portion 123. The plurality of leg portions 125 may each extend perpendicularly to the direction in which the body portion 123 extends. The plurality of leg portions 125 may be spaced apart from each other in the stacking direction. In this specification, the height direction may mean a direction parallel to the Z-axis direction.

Referring to FIG. 4, the body portion 123 may extend in the Y-axis direction. The plurality of leg portions 125 may extend in the Z-axis direction in one region of the body portion 123. In an embodiment, the plurality of leg portions 125 may each extend downward from the body portion 123. The plurality of leg portions 125 may be spaced apart from each other in the Y-axis direction. In an embodiment, the body portion 123 may be integrally formed with the plurality of leg portions 125.

The plurality of slits 121 may be formed between the plurality of leg portions 125. The plurality of leg portions 125 may be spaced apart from each other, and the slits 121 may be formed between the leg portions 125 spaced apart from each other. In other words, the slit 121 may be formed between one leg portion 125 of the plurality of leg portions 125 and another leg portion 125.

In an embodiment, a width L0 of each of the plurality of leg portions 125 may be the same. In addition, a width L4 between the plurality of leg portions 125 may be the same because the width of the electrode leads 131 may be the same.

In an embodiment, the width LO of each of the plurality of leg portions 125 may be greater than the width L4 between the plurality of leg portions 125.

In an embodiment, the slit 121 may include an opening which opens toward one edge of the busbar assembly 120. The opening allows the electrode lead 131 to be inserted into the slit 121. The busbar assembly 120 may move towards the electrode lead 131 and the electrode lead 131 may be inserted into the slit 121.

The busbar assembly 120 may further include a plurality of support portions 127 which extend from one side of the plurality of leg portions 125 toward the plurality of slits 121 and are disposed to face each other. One side of the plurality of leg portions 125 may mean one side where one leg portion 125 faces another leg portion 125.

One side of the plurality of leg portions 125 may not mean only one edge of any one leg portion 125, but may mean two different edges. Referring to FIGS. 4 to 6, when other leg portions 125 are located on both sides of one leg portion 125, the support portions 127 may be formed on both sides of the one leg portion 125.

The support portion 127 may protrude by a predetermined length. The support portion 127 may support the first region 1311. That is, the support portion 127 may be in contact with the first region 1311 to restrict a movement range of the first region 1311.

An insertion process of the electrode leads 131 will be described with reference to FIG. 4. First, the battery cells 130 may be arranged in the predetermined stacking direction. The electrode leads 131 may protrude to one side and the other side of the battery cells 130, respectively.

The busbar assembly 120 may be positioned on top of the electrode lead 131 such that the position of the slit 121 may correspond to the electrode lead 131. Thereafter, the busbar assembly 120 may be moved toward the electrode lead 131, and the electrode lead 131 may be inserted into the slit 121.

The length of the slit 121 in the height direction may be greater than the length of the electrode lead 131, whereby the electrode lead 131 may be fully inserted into the busbar assembly 120. Referring to FIGS. 5 and 6, the electrode lead 131 may be inserted into the slit 121 and connected to the busbar assembly 120. The first region 1311 of the electrode lead 131 may be in contact with the busbar assembly 120. In an embodiment, one end of the first region 1311 may be flat.

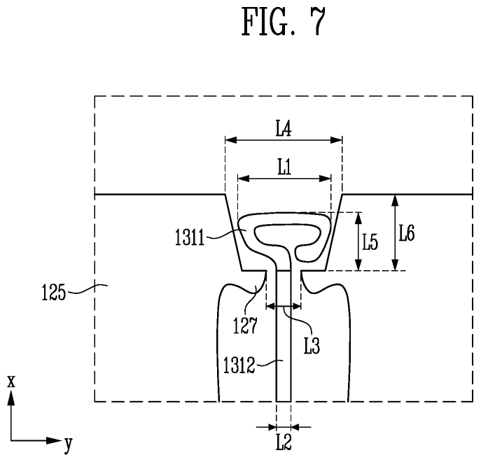

FIG. 7 is an enlarged view of a cross-section of an area S of FIG. 6. The positions of the busbar assembly 120 and the electrode lead 131 will be described in detail with reference to FIG. 7.

The first region 1311 may be located inward relative to one surface of the busbar assembly

120. The first region 1311 may be located in one surface of the busbar assembly 120 in the protruding direction of the electrode lead 131.

One surface of the busbar assembly 120 may be located farther from the battery cell 130 than one end of the first region 1311. In other words, one surface of the busbar assembly 120 may protrude from one end of the first region 1311.

Welding may be facilitated when the first region 1311 is located inward relative to one surface of the busbar assembly 120. When the first region 1311 protrudes further than the busbar assembly 120, light may leak out. Thus, an angle at which the laser is irradiated may be considered.

The battery module 100 of the present disclosure may relatively not consider the angle at which the laser is irradiated when the electrode leads 131 and the busbar assembly 120 are welded. In an embodiment, the electrode leads 131 and the busbar assembly 120 of the present disclosure may be vertically welded. Thus, welding quality may be improved and production efficiency may be improved.

In addition, when the first region 1311 protrudes further than the busbar assembly 120, the melt spreading property may be considered depending on a plating material. Thus, the protruding length is necessarily controlled to a predetermined length. In addition, there may be some cases where metals which satisfy predetermined conditions need to be used.

However, in the battery module 100 of the present disclosure, since the first region 1311 is located inward relative to one surface of the busbar assembly 120, the melt spreading property may not be considered, so that the production efficiency may be improved and the welding quality may be improved.

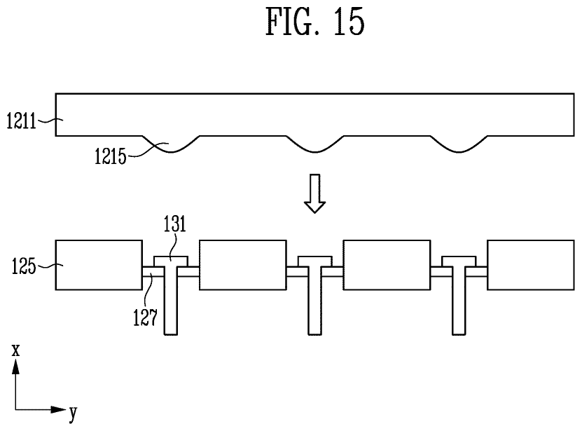

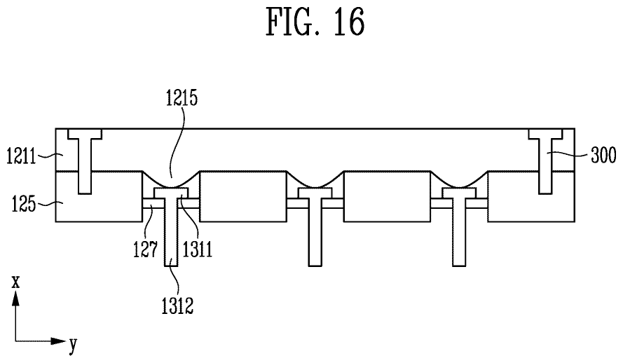

On the other hand, the electrode lead 131 and the busbar assembly 120 are not necessarily welded. In another embodiment, the battery module 100 of the present disclosure may include a busbar cover 1211 without welding the electrode lead 131 and the busbar assembly 120. This will be explained in detail below with reference to FIGS. 15 and 16.

A width L4 between the plurality of leg portions 125 in the stacking direction may be greater than the width L1 of the first region 1311, and the width L1 in the first region 1311 may be greater than a width L3 between the plurality of support portions 127.

Referring again to FIG. 7, the width L4 between the plurality of leg portions 125 may mean a width between one leg portion 125 and another leg portion 125. As a result, the first region 1311 may be positioned between the plurality of leg portions 125.

Referring to FIG. 7, the width L3 between the plurality of support portions 127 may mean a width between one support portion 127 and another support portion 127 facing the one support portion 127. This structure prevents the first region 1311 from passing between the plurality of supports 127.

Further, referring to FIG. 7, a distance L6 from the support portion 127 to one surface of the busbar assembly 120 may be less than or equal to a distance L5 from the support portion 127 to one end of the first region 1311 in the protruding direction of the electrode lead 131.

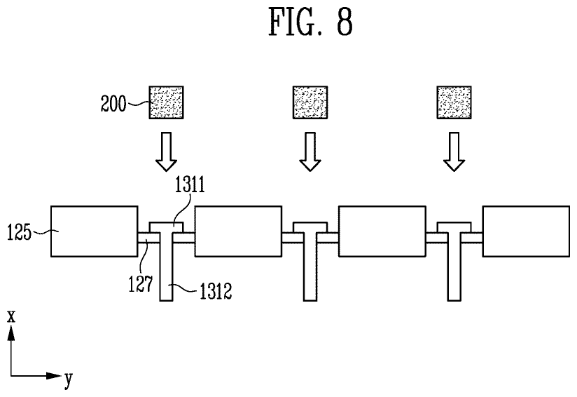

FIG. 8 illustrates a state in which the electrode leads 131 are pressed according to an embodiment of the present disclosure.

A guide block 200 may press the electrode lead 131 in the protruding direction of the electrode lead 131. The guide block 200 may press the first region 1311. As a result, the first region 1311 may be prevented from protruding further than the outer surface of the busbar assembly 120. In addition, the first region 1311 may be in close contact with the busbar assembly 120. In an embodiment, the first region 1311 may be in close contact with the support portion 127.

The guide block 200 may include a plurality of guide blocks. The plurality of guide blocks 200 may simultaneously press the plurality of first regions 1311. In addition, the guide block 200 may make one surface of the first region 1311 flat.

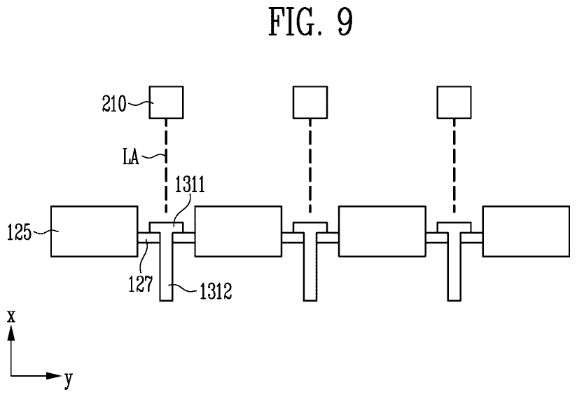

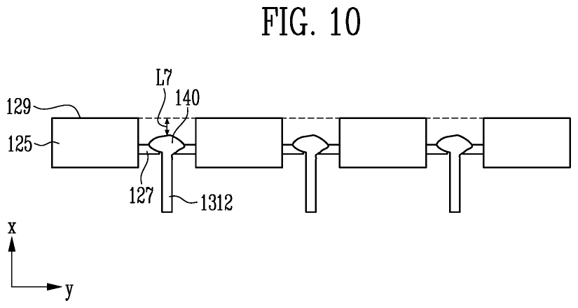

FIG. 9 illustrates a state in which the electrode leads 131 and the busbar assembly 120 are welded to each other according to an embodiment of the present disclosure, and FIGS. 10 to 13 illustrate a state in which the electrode leads 131 and the busbar assembly 120 are welded to one another according to an embodiment.

The battery module 100 of the present disclosure may further include a weld bead 140 formed by melting at least a part of the first region 1311 and a part of the busbar assembly 120.

In an embodiment, a portion of the support portion 127 or the leg portion 125 may be melted and then solidified to form the weld bead 140.

Welding may proceed by irradiating the electrode lead 131 with a laser. In an embodiment, a laser portion 210 may irradiate the electrode lead 131 with a laser. As described above, the first region 1311 is positioned inward relative to one surface of the busbar assembly 120, so that the angle of the laser portion 210 may be formed perpendicular to the busbar assembly 100.

Referring to FIG. 9, the laser portion 210 may be perpendicular to the busbar assembly 120 and irradiate a laser LA onto the electrode lead 131.

The weld bead 140 may be formed by melting at least a portion of the first region 1311 and at least a portion of the busbar assembly 120. As a result, the first region 1311 and the busbar assembly 120 may be electrically connected to each other. In addition, the first region 1311 may be physically fixed to the busbar assembly 120.

The weld bead 140 may be located inward relative to one surface of the busbar assembly 120. In the protruding direction of the electrode lead 131, the weld bead 140 may be located inward relative to one surface of the busbar assembly 120. The weld bead 140 may be located inward relative to one surface of the plurality of leg portions.

With such a structure, welding quality may be improved and the performance of the battery module 100 may be improved. Referring to FIG. 10, the weld bead 140 may be spaced a distance L7 from a virtual line extending from one side 129 of the busbar assembly 120. The distance L7 may vary depending on the welding conditions, the welding environment, and the performance required by the user.

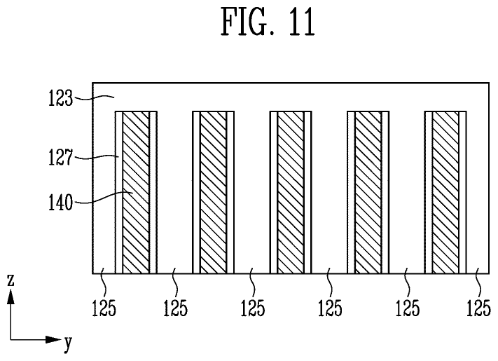

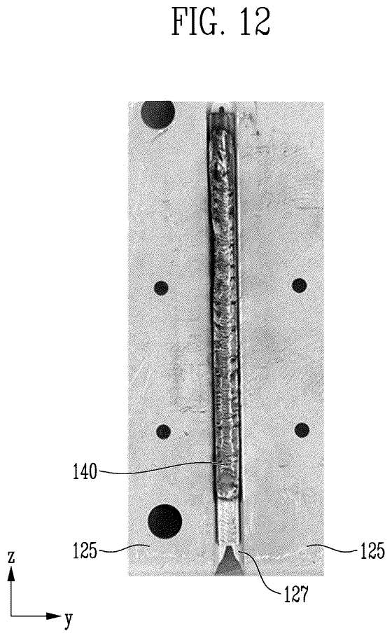

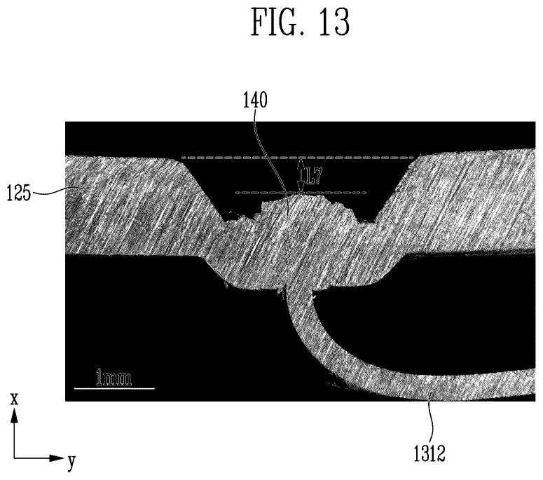

More specifically, FIG. 11 is a schematic view showing a state in which the weld beads 140 are formed as viewed from the front. FIG. 12 is a photograph, and FIG. 13 is a photograph of a cross-section of the weld bead 140.

Referring to FIGS. 11 to 13, the weld bead 140 may be positioned between the plurality of leg portions 125. The weld bead 140 may also extend in the direction in which the first region 1311 extends. In other words, the weld bead 140 may extend in the height direction perpendicular to the stacking direction and the protruding direction of the electrode lead 131. In an embodiment, the weld bead 140 may extend in the Z-axis direction.

In an embodiment, the weld bead 140 may cover at least a portion of the support portion 127. At least a portion of the first region 1311 and a portion of the busbar assembly 120 may move while being melted and solidified.

The weld bead 140 may be positioned on the support portion 127, which may mean that the weld bead 140 is located on the outer surface of the support portion 127 in the protruding direction.

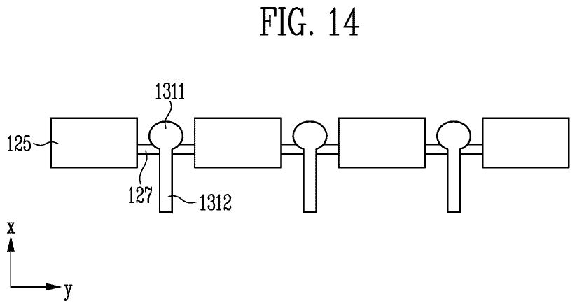

FIG. 14 illustrates the electrode leads 131 according to another embodiment of the present disclosure.

The electrode lead 131 of the present disclosure may have various shapes. For example, the first region 1311 of the electrode lead 131 taken in a direction parallel to the protruding direction of the electrode lead 131 may have a circular shape, a polygonal shape, an elliptical shape, or a combination thereof.

Referring to FIG. 14, a cross-section of the first region 1311 may be formed as a circular shape. A width of the first region 1311 having the circular shape may be greater than a width between the plurality of support portions 127. In addition, a width between the plurality of leg portions 125 may be greater than a width of the first region 1311. As a result, the first region 1311 may be located inward relative to one surface of the busbar assembly 120.

FIGS. 15 and 16 illustrate the busbar cover 1211 according to an embodiment of the present disclosure.

The battery module 100 of the present disclosure further includes the busbar cover 1211 which covers the busbar assembly 120, and the busbar cover 1211 may be in contact with the first region 1311.

The busbar cover 1211 may cover one surface of the busbar assembly 120. The busbar assembly 120 may include a first surface facing the plurality of battery cells 130 and a second surface opposite thereto. The busbar cover 1211 may cover the second surface.

The busbar cover 1211 may be located opposite to the busbar assembly 120. Referring to FIG. 1, although the busbar cover 1211 is not shown, the busbar cover 1211 may be disposed outside the busbar assembly 120 in the X-axis direction.

The busbar cover 1211 may protect the first region 1311 exposed to the outside of the slit 121. In addition, the busbar cover 1211 may contact the first region 1311 and be electrically connected thereto. Thus, the busbar cover 1211 may include an electrically conductive material.

The busbar cover may include protrusions 1215 in which portions of the busbar cover corresponding to the plurality of slits protrude toward the electrode leads. The busbar cover 1211 may be formed with one protruding area, which comes in contact with the first region 1311. When the busbar cover 1211 is flat, the busbar assembly 120 may prevent the busbar assembly 120 from contacting the first region 1311.

Referring to FIG. 15, areas of one surface of the busbar cover 1211 at positions corresponding to the plurality of slits 121 may protrude toward the electrode leads 131 to form the protrusions 1215. The protrusion 1215 may contact the first region 1311, and at the same time, the busbar cover 1211 may protect the first region 1311.

On the other hand, after the busbar cover 1211 comes close to the busbar assembly 120, the busbar cover 1211 and the busbar assembly 120 may be fixed to each other by a coupling portion 300. The coupling portion 300 may penetrate at least a part of the busbar cover 1211 and the busbar assembly 120. In an embodiment, the coupling portion 300 may be a screw. Alternatively, the busbar cover 1211 and the busbar assembly 120 may be fixed by welding or an adhesive.

Referring to FIG. 16, one surface of the busbar cover 1211 and one surface of the busbar assembly 120 are in contact with each other, and a protruding portion of the busbar cover 1211 may be in contact with the first region 1311.

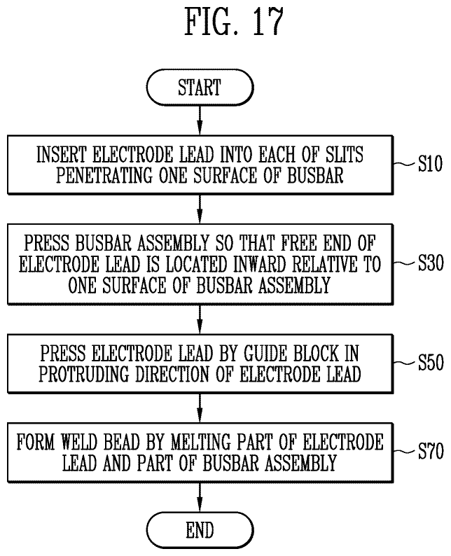

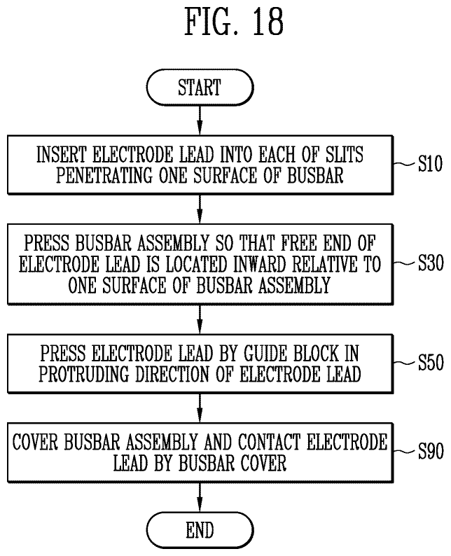

FIGS. 17 and 18 illustrate an order of a method of manufacturing the battery module 100 according to an embodiment of the present disclosure.

A method of manufacturing the battery module 100 according to the present disclosure includes: inserting the plurality of electrode leads 131 into the plurality of slits 121, respectively, which penetrate one surface of the busbar assembly 120; and pressing the busbar assembly 120 so that the free ends of the electrode leads 131 may be located inward relative to one surface of the busbar assembly 120.

The manufacturing method of the present disclosure may include step S10 of inserting the electrode lead s131 into the plurality of slits 121 first. In step S10 of inserting each electrode lead 131, the manufacturing method of the present disclosure may include moving the busbar assembly 120 in the height direction perpendicular to the stacking direction and the protruding direction of the electrode lead 131. Referring to FIG. 4, each of the electrode leads 131 may be inserted into each of the slits 121 by moving the busbar assembly 120 in the Z-axis direction.

Subsequently, the manufacturing method of the present disclosure may include step S30 of pressing the busbar assembly 120 so that the free end of the electrode lead 131 may be located inward relative to one surface of in the busbar assembly 100.

When the electrode lead 131 is inserted into the slit 121, the free end of the electrode lead 131 may protrude further than the busbar assembly 120. To prevent this, the busbar assembly 120 is pressed so that the free end of the electrode lead 131 may be positioned in the busbar assembly 100.

Referring to FIGS. 4 to 6, the busbar assembly 120 may be pressed outward in the X-axis direction. When the busbar assembly 120 comes into contact with the free end of the electrode lead 131, the busbar assembly 100 will no longer be able to move. In an embodiment, the free end of the electrode lead 131 may mean the first region 1311.

In an embodiment, the manufacturing method of the present disclosure may further include step S50 in which the guide block 200 presses the electrode lead 131 in the protruding direction of the electrode lead 131. According to the manufacturing method of the present disclosure, after step S30 of pressing the busbar assembly 120 is performed, step S50 of pressing the electrode lead 131 may be performed. As a result, one end of the electrode lead 131 may be flattened, and welding quality may be improved during welding.

In an embodiment, the manufacturing method of the present disclosure may include step S70 of melting a part of the electrode lead 131 and a part of the busbar assembly 120 to form the weld bead 140.

Referring to FIG. 17, the manufacturing method of the present disclosure may include step S70 of forming the weld bead 140 after step S10 of inserting the plurality of electrode leads 131 into the plurality of slits 121.

In the manufacturing method of the present disclosure, step S30 of pressing the busbar assembly 120 and step S50 of pressing the electrode lead 131 by the guide block 200 may be performed between step S70 of forming the weld bead 140 and step S10 of inserting the plurality of electrode leads 131 into the plurality of slits 121.

By forming the weld bead 140, the electrode lead 131 and the busbar assembly 120 may be stably coupled. On the other hand, in step S70 of forming the weld bead 140, the weld bead 140 may be formed inward with respect to one surface of the busbar assembly 120 in the protruding direction of the electrode lead 131.

In an embodiment, in step S70 of forming the weld bead 140, the manufacturing method of the present disclosure may include irradiating the electrode lead 131 with a laser in a direction perpendicular to one surface of the busbar assembly 120. Referring to FIG. 9, the laser portion 210 may irradiate the first region 1311 with a laser.

In another embodiment, the manufacturing method of the present disclosure may include step S90 in which the busbar cover 1211 covers the busbar assembly 120 and contacts the electrode lead 131.

In the manufacturing method of the present disclosure, when step S90 in which the busbar cover 1211 covers the busbar assembly 120 and contacts the electrode lead 131 is included, step S70 of forming the weld bead 140 may not be performed. In an embodiment, the busbar cover 1211 may be in contact with the first region 1311 of the electrode lead 131.

Referring to FIG. 18, in the manufacturing method of the present disclosure, after step S10 of inserting the electrode lead 131 into each of the plurality of slits 121, step S90 of bringing the busbar cover 131 into contact with the electrode lead 131 may be performed.

In the manufacturing method of the present disclosure, step S30 of pressing the busbar assembly 120 and step S50 of pressing the electrode lead 131 by the guide block 200 may be performed between step S90 of bringing the busbar cover 1211 in contact with the electrode lead 131 and step S10 of inserting the plurality of electrode leads 131 into the plurality of slits 121.

According to an embodiment of the present disclosure, a battery module with improved stability may be provided.

According to another embodiment of the present disclosure, a battery module manufacturing method with improved production efficiency may be provided.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A battery module comprising:
a plurality of battery cells each including an exterior material and an electrode lead protruding to one side, and stacked in a predetermined stacking direction; and
a busbar assembly facing the plurality of battery cells and electrically connected to the electrode lead,
wherein the electrode lead includes a first region located at a free end and a second region connected to the exterior material, and
wherein the first region is located inward relative to one surface of the busbar assembly.

2. The battery module according to claim 1, wherein the busbar assembly comprises a plurality of slits, and the electrode lead is inserted into each of the plurality of slits.

3. The battery module according to claim 2, wherein the plurality of slits are spaced apart from each other in the predetermined stacking direction.

4. The battery module according to claim 1, further comprising a weld bead formed by melting at least a part of the first region and a part of the busbar assembly.

5. The battery module according to claim 4, wherein the weld bead is located inward relative to the one surface of the busbar assembly.

6. The battery module according to claim 4, wherein the busbar assembly comprises a body portion extending in the predetermined stacking direction and a plurality of leg portions extending from the body portion in a height direction perpendicular to the predetermined stacking direction and a protruding direction of the electrode lead to form the plurality of slits.

7. The battery module according to claim 6, wherein the weld bead is located inward relative to the one surface of the plurality of leg portions.

8. The battery module according to claim 6, wherein the busbar assembly further comprises a plurality of support portions extending from one side of the plurality of leg portions toward the plurality of slits and arranged to face each other.

9. The battery module according to claim 8, wherein a width between the plurality of leg portions in the predetermined stacking direction is greater than a width of the first region, and the width of the first region is greater than a width between the plurality of support portions.

10. The battery module according to claim 8, wherein the weld bead is located on the plurality of support portions.

11. The battery module according to claim 4, wherein the weld bead extends in a height direction perpendicular to the predetermined stacking direction and a protruding direction of the electrode lead.

12. The battery module according to claim 2, further comprising a busbar cover covering the busbar assembly,
wherein the busbar cover is in contact with the first region.

13. The battery module according to claim 12, wherein the busbar cover comprises protrusions in which portions of the busbar cover at positions corresponding to the plurality of slits protrude toward the electrode lead.

14. A method of manufacturing a battery module including a plurality of battery cells each including an electrode lead protruding to one side and stacked in a predetermined stacking direction, and a busbar assembly facing the plurality of battery cells and electrically connected to the electrode lead, the method comprising:
inserting the electrode lead into each of a plurality of slits penetrating one surface of the busbar assembly; and
pressing the busbar assembly such that a free end of the electrode lead is located inward relative to the one surface of the busbar assembly.

15. The method according to claim 14, wherein the inserting the electrode lead comprises moving the busbar assembly in a height direction perpendicular to the predetermined stacking direction and a protruding direction of the electrode lead.

16. The method according to claim 14, further comprising pressing the electrode lead in a protruding direction of the electrode lead by a guide block.

17. The method according to claim 14, further comprising forming a weld bead by melting a part of the electrode lead and a part of the busbar assembly.

18. The method according to claim 17, wherein the forming the weld bead comprises irradiating the electrode lead with a laser in a direction perpendicular to the one surface of the busbar assembly.

19. The method according to claim 17, wherein in the forming of the weld bead, the weld bead is formed inward in a protruding direction of the electrode lead relative to the one surface of the busbar assembly.

20. The method according to claim 14, further comprising covering the busbar assembly and contacting the electrode lead by a busbar cover.
